(19) United States
(12) Patent Application Publication
(10) Pub. No.: US 2024/0040329 A1
(43) Pub. Date: Feb. 1, 2024

(54) AUDIO REPRODUCTION DEVICE AND AUDIO REPRODUCTION LSI

(71) Applicant: LAPIS Technology Co., Ltd., Yokohama (JP)

(72) Inventor: Hirokazu HOSOKAWA, Yokohama (JP)

(73) Assignee: LAPIS Technology Co., Ltd., Yokohama (JP)

(21) Appl. No.: 18/356,202

(22) Filed: Jul. 20, 2023

(30) Foreign Application Priority Data
Jul. 29, 2022 (JP) 2022-121445

(51) Int. Cl. H04S 7/00; H04R 5/04

(52) U.S. Cl. CPC H04S 7/307; H04R 5/04; H04S 2400/13

(57) ABSTRACT

The audio reproduction device includes a reproduction control part reproducing audio in each of (n+1) channels (n is a natural number), (n+1) reproduction setting value registers corresponding to the (n+1) channels and storing a reproduction setting value related to reproduction control of audio reproduced in each channel, a first common line which is shared by the (n+1) reproduction setting value registers and through which the reproduction setting value is supplied from the outside, a second common line which is shared by the (n+1) reproduction setting value registers and through which a common writing signal for storing the reproduction setting value in the reproduction setting value register receiving supply of the reproduction setting value via the first common line is supplied, and an association setting part selectively blocking the common writing signal supplied to the second common line with respect to one or a plurality of the reproduction setting value registers.

### CROSS-REFERENCE TO RELATED APPLICATION

This application claims priority under 35 USC 119 from Japanese Patent Application No. 2022-121445 filed on Jul. 29, 2022, the disclosure of which is incorporated by reference herein.

### BACKGROUND

### Technical Field

The disclosure relates to an audio reproduction device and an audio reproduction LSI.

### Description of Related Art

Regarding electric vehicles or electric hybrid vehicles traveling by means of an electric motor, since they make extremely less noise than engined cars at the time of low-speed traveling, vehicles equipped with a vehicle approach notification device that generates a sound for informing the outside of the vehicle of approach of a host vehicle (which will hereinafter be referred to as a vehicle approach sound) are commercialized. When the vehicle is traveling at a speed lower than a predetermined speed, the vehicle approach notification device changes a timbre of the vehicle approach sound in response to a traveling velocity thereof.

Regarding such a vehicle approach notification device, a device including a memory in which a plurality of pieces of timbre generation data having timbres different from each other is stored in advance in association with traveling velocities of a vehicle in advance has been proposed (for example, refer to Patent Document 1 (Japanese Patent Laid-Open No. 2011-207390)).

In the vehicle approach notification device, first, a timbre generation data piece indicating a synthesized sound corresponding to a current traveling velocity of the vehicle is read from the memory. Further, the vehicle approach notification device converts a combination of timbre generation data pieces which have been sequentially read from the memory into an analog audio signal and acoustically outputs this to the outside of the vehicle through a speaker.

In an in-vehicle audio reproduction device such as a vehicle approach notification device, a channel for outputting different audio such as an alarm or navigation audio is provided in addition to a channel for outputting motor sound of a vehicle, and a plurality of kinds of audio is simultaneously output. In such an audio reproduction device having a plurality of channels, a pitch and a volume of each channel are adjusted by individually changing setting values of a pitch adjustment register and a volume adjustment register provided for each channel.

Such an audio reproduction device is constituted of an audio reproduction LSI outputting audio and a host microcomputer controlling the audio reproduction LSI, for example. When a pitch and a volume are adjusted with respect to a plurality of channels, setting values for a plurality of registers are required. Therefore, when such setting is performed from the outside of the host microcomputer or the like via a serial interface, there is a problem that it takes a time to perform setting and a time lag occurs in a timing at which setting change is reflected. In addition, there is a problem that the host microcomputer is required to have high processing capability such that the quality of sound is not affected even when setting is changed during reproduction.

The disclosure provides an audio reproduction device capable of smoothly adjusting a pitch and a volume of audio in a plurality of channels during audio reproduction.

### SUMMARY

An audio reproduction device according to the disclosure is an audio reproduction device capable of simultaneously reproducing audio in a plurality of channels. The audio reproduction device includes a reproduction control part which reproduces audio in each of (n+1) channels (n is a natural number), (n+1) reproduction setting value registers which are provided respectively corresponding to the (n+1) channels and store a reproduction setting value that is a setting value related to reproduction control of audio reproduced in each channel, a first common line which is shared by the (n+1) reproduction setting value registers and through which the reproduction setting value is supplied from the outside, a second common line which is shared by the (n+1) reproduction setting value registers and through which a common writing signal for storing the reproduction setting value in the reproduction setting value register that has received supply of the reproduction setting value via the first common line is supplied, and an association setting part which is able to selectively block the common writing signal supplied to the second common line with respect to one or a plurality of the reproduction setting value registers.

In addition, an audio reproduction LSI according to the disclosure includes a reproduction control part which reproduces audio in each of (n+1) channels (n is a natural number), (n+1) reproduction setting value registers which are provided respectively corresponding to the (n+1) channels and store a reproduction setting value that is a setting value related to reproduction control of audio reproduced in each channel, a first common line which is shared by the (n+1) reproduction setting value registers and through which the reproduction setting value is supplied from the outside, a second common line which is shared by the (n+1) reproduction setting value registers and through which a common writing signal for storing the reproduction setting value in the reproduction setting value register that has received supply of the reproduction setting value via the first common line is supplied, and an association setting part which is able to selectively block the common writing signal supplied to the second common line with respect to one or a plurality of the reproduction setting value registers.

According to the audio reproduction device of the disclosure, a pitch and a volume of audio in a plurality of channels can be smoothly adjusted during audio reproduction.

### BRIEF DESCRIPTION OF THE DRAWINGS

FIG. 1 is a block diagram showing a constitution of a vehicle approach notification system.

FIG. 2 is a block diagram showing a basic constitution of an audio reproduction device.

FIG. 3 is a block diagram showing an internal constitution of the audio reproduction device of Example 1.

FIG. 4 is a block diagram showing an internal constitution of an audio reproduction device of Example 2.

### DESCRIPTION OF THE EMBODIMENT

Examples of the disclosure will be described below in detail. In description and the accompanying drawings of each of the following examples, the same reference signs are applied to parts which are substantially the same or equivalent.

### EXAMPLE 1

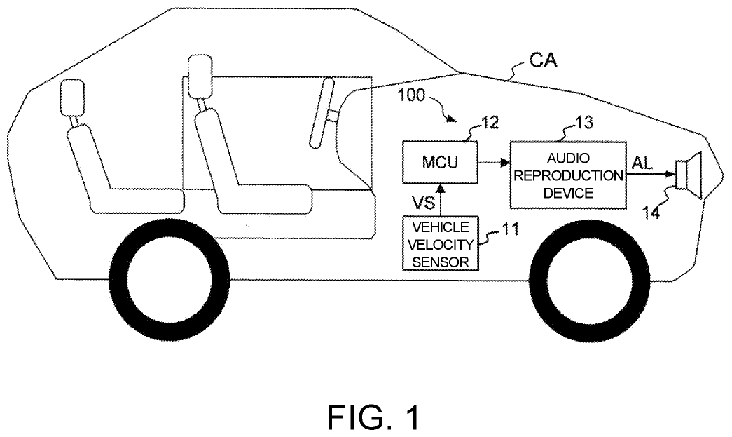

FIG. 1 is a block diagram showing a constitution of a vehicle approach notification system 100 according to the disclosure. The vehicle approach notification system 100 is an audio outputting system mounted in a vehicle CA and issues notification of approach of the vehicle CA by outputting audio corresponding to a traveling velocity of the vehicle CA (that is, a vehicle velocity).

The vehicle approach notification system 100 has a vehicle velocity sensor 11, an MCU 12, an audio reproduction device 13, and a speaker 14.

The vehicle velocity sensor 11 detects the traveling velocity of the vehicle CA and supplies a velocity signal VS indicating information of the traveling velocity to the MCU 12.

The micro controller unit (MCU) 12 is a host microcomputer controlling audio reproduction operation by the audio reproduction device 13. The MCU 12 controls the audio reproduction device 13 on the basis of the velocity signal VS and reproduces a vehicle approach sound having a pitch and a volume corresponding to the traveling velocity of the vehicle CA.

The audio reproduction device 13 is a reproduction device performing reproduction of audio data and is constituted as a large scale integration circuit (LSI). The audio reproduction device 13 has a plurality of channels for audio reproduction and is constituted to be able to simultaneously reproduce different kinds of audio by reproducing audio in the channels in parallel. In the present example, the audio reproduction device 13 has (n+1) channels from a channel 0 to channel n.

The channel 0 is a channel used for reproducing and outputting a vehicle approach sound. The audio reproduction device 13 generates a vehicle approach sound signal AL corresponding to the traveling velocity of the vehicle CA in response to control of the MCU 12 and supplies it to the speaker 14.

The channel 1 to the channel n is a channel used for reproducing and outputting of different audio other than a vehicle approach sound. For example, the audio reproduction device 13 is connected to an in-vehicle navigation device and generates navigation audio acquired from the navigation device or an audio signal expressing an alarm sound as a different audio signal. The audio reproduction device 13 supplies a generated different audio signal to an internal speaker (illustration omitted) provided inside the vehicle CA.

For example, the speaker 14 is installed in a front bumper of the vehicle CA and emits an audible sound based on the vehicle approach sound signal AL to a space outside the vehicle CA as a vehicle approach sound AS.

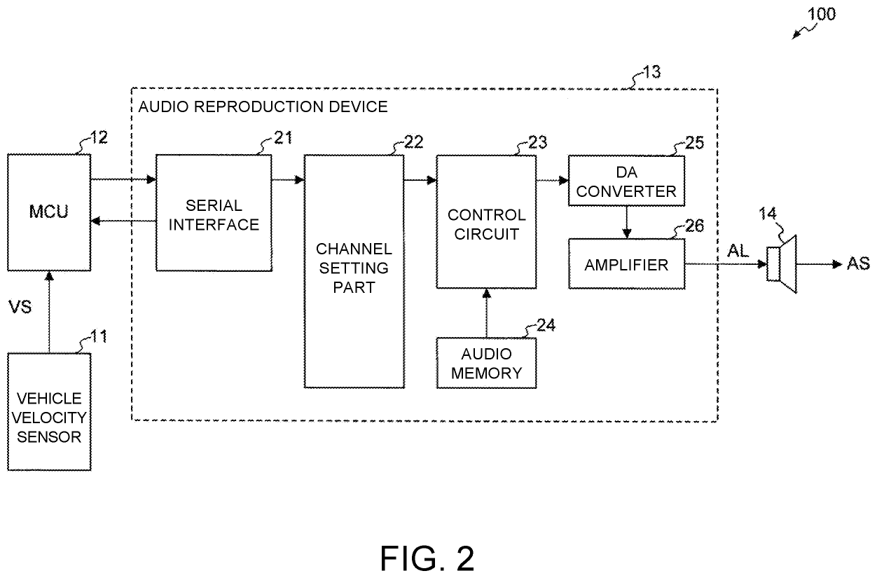

FIG. 2 is a block diagram showing an internal constitution of the audio reproduction device 13.

The audio reproduction device 13 has a serial interface 21, a channel setting part 22, a control circuit 23, an audio memory 24, a DA converter 25, and an amplifier 26.

The serial interface 21 is an interface for serial communication used for data transmission from the MCU 12 to the audio reproduction device 13 and is constituted of a serial peripheral interface (SPI), for example.

The channel setting part 22 is a setting part for setting reproduction parameters with respect to each of the (n+1) channels from the channel 0 to the channel n. The reproduction parameters are set by serial communication from the MCU 12 via the serial interface 21. In the present example, a pitch (frequency) and a volume (sound volume) of a reproduced sound in each channel are set as the reproduction parameters.

The control circuit 23 reads audio data from the audio memory 24 and reproduces audio on the basis of the read audio data. In addition, the control circuit 23 acquires audio data of navigation audio and an alarm sound from the navigation device (not illustrated) and reproduces audio on the basis of the acquired audio data.

For example, the audio memory 24 is constituted of a nonvolatile semiconductor memory such as a NAND or NOR flash memory or a programmable ROM (PROM), or a storage medium such as a magnetic recording hard disk. The audio memory 24 stores a plurality of series of audio data (that is, serial audio data) corresponding to the traveling velocity of the vehicle CA.

The DA converter 25 is a digital-analog converter which receives an input of digital data, converts this into analog data, and outputs it. The DA converter 25 generates an analog audio reproduction signal by performing D/A conversion of audio reproduction data reproduced by the control circuit 23.

The amplifier 26 amplifies an audio reproduction signal generated by the DA converter and outputs it as the vehicle approach sound signal AL. The vehicle approach sound signal AL output from the amplifier 26 is output to the outside of the vehicle CA from the speaker 14 as the vehicle approach sound AS.

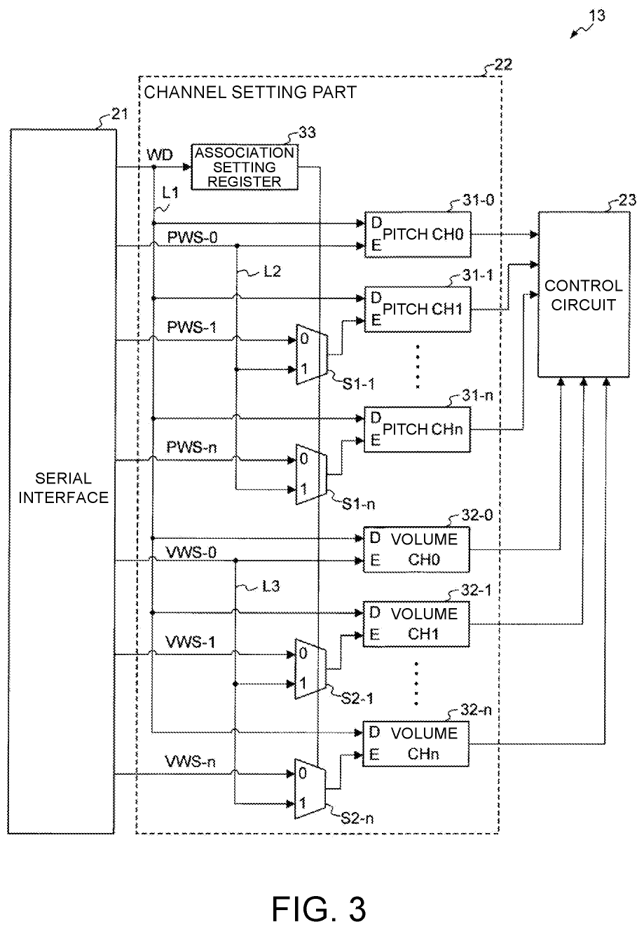

FIG. 3 is a block diagram showing an internal constitution of the channel setting part 22.

The channel setting part 22 has pitch setting registers 31-0 to 31-n, volume setting registers 32-0 to 32-n, selectors S1-1 to S1-n, selectors S2-1 to S2-n, and an association setting register 33 (n is a natural number).

The pitch setting register 31-0 is a register for storing a pitch setting value that is a setting value for a frequency in audio reproduction in the channel 0. The pitch setting value is supplied from the MCU 12 to the audio reproduction device 13 via the serial interface 21 and is supplied to the pitch setting register 31-0 through a first common line L1 that is a supply line for writing data WD common to every channel.

The pitch setting register 31-0 has a data input terminal D for receiving an input of the pitch setting value as the writing data WD, and an enable terminal E for receiving an input of a writing signal PWS-0 for instructing writing of the pitch setting value (that is, storage in the register). The data input terminal D is connected to the first common line L1. The enable terminal E is connected to a second common line L2 that is a supply line for a writing signal common to every channel.

For example, when the writing signal PWS-0 of a logic level 1 is input to the enable terminal E, the pitch setting value (writing data WD) supplied via the first common line L1 is input to the data input terminal D and is stored in the pitch setting register 31-0.

The pitch setting register 31-1 is a register for storing the pitch setting value regarding audio reproduction in the channel 1.

The pitch setting register 31-1 has the data input terminal D for receiving an input of the pitch setting value as the writing data WD, and the enable terminal E for receiving an input of a writing signal for instructing writing of the pitch setting value. The data input terminal D is connected to the first common line L1. The enable terminal E is connected to an output end of the selector S1-1.

The selector S1-1 is a selector for selectively outputting any one of a signal input to an input end “0” and a signal input to an input end “1” from the output end. Switching of an output signal is performed on the basis of an association setting value stored in the association setting register 33.

In the present example, a writing signal PWS-1 which is a writing signal unique to the channel 1 is supplied to the input end “0” of the selector S1-1. The writing signal PWS-1 is supplied from the MCU 12 to the audio reproduction device 13 via the serial interface 21 and is supplied to the input end “0” of the selector S1-1 through a writing signal supply line unique to the channel 1 which is provided separately from the second common line L2.

The input end “1” of the selector S1-1 is connected to the second common line L2, and a writing signal PWS-0 of the channel 0 is supplied as a common writing signal.

The selector S1-1 switches a signal output from the output end on the basis of the association setting value stored in the association setting register 33. Specifically, when the association setting value is “0”, a signal input to the input end “0”, that is, the writing signal PWS-1 which is a writing signal unique to the channel 1 is output from the output end. On the other hand, when the association setting value is “1”, a signal input to the input end “1”, that is, the writing signal PWS-0 which is a writing signal common to the channel 0 is output from the output end.

The pitch setting registers 31-2 to 31-n also have a constitution similar to that of the pitch setting register 31-1. That is, the pitch setting registers 31-2 to 31-n are registers for storing pitch setting values regarding audio reproduction in the channels 2 to n and have the data input terminal D and the enable terminal E. The data input terminal D of each of the pitch setting registers 31-2 to 31-n is connected to the first common line L1. The enable terminal E of each of the pitch setting registers 31-2 to 31-n is connected to each of the output ends of the selectors S1-2 to S1-n provided respectively corresponding thereto.

Similar to the selector S1-1, the selectors S1-2 to S1-n are selectors for selectively outputting any one of a signal input to the input end “0” and a signal input to the input end “1” from the output end in accordance with the association setting value stored in the association setting register 33. The writing signals PWS-1 to PWS-n unique to the respective channels are supplied to an input terminal “0” of each of the selectors S1-2 to S1-n. The writing signals PWS-1 to PWS-n are respectively supplied to the input terminals “0” of the selectors S1-2 to S1-n through the writing signal supply lines provided in the respective channels.

The input ends “1” of the selectors S1-2 to S1-n are connected to the second common line L2, and the writing signal PWS-0 of the channel 0 is supplied as a common writing signal.

The volume setting register 32-0 is a register for storing a volume setting value that is a setting value for a sound volume in audio reproduction in the channel 0. The volume setting value is supplied from the MCU 12 to the audio reproduction device 13 via the serial interface 21 and is supplied to the volume setting register 32-0 through the first common line L1 that is a supply line for the writing data WD common to every channel.

The volume setting register 32-0 has the data input terminal D for receiving an input of the volume setting value as the writing data WD, and the enable terminal E for receiving an input of a writing signal VWS-0 for instructing writing of the volume setting value (that is, storage in the register). The data input terminal D is connected to the first common line L1. The enable terminal E is connected to a third common line L3 that is a supply line for a writing signal common to every channel.

For example, when the writing signal VWS-0 of the logic level 1 is input to the enable terminal E, the volume setting value (writing data WD) supplied via the first common line L1 is input to the data input terminal D and is stored in the volume setting register 32-0.

The volume setting register 32-1 is a register for storing the volume setting value regarding audio reproduction in the channel 1.

The volume setting register 32-1 has the data input terminal D for receiving an input of the volume setting value as the writing data WD, and the enable terminal E for receiving an input of a writing signal for instructing writing of the volume setting value. The data input terminal D is connected to the first common line L1. The enable terminal E is connected to the output end of the selector S2-1.

The selector S2-1 is a selector for selectively outputting any one of a signal input to the input terminal “0” and a signal input to an input terminal “1”. Switching of an output signal is performed on the basis of the association setting value stored in the association setting register 33.

In the present example, a writing signal VWS-1 which is a writing signal unique to the channel 1 is supplied to the input end “0” of the selector S2-1. The writing signal VWS-1 is supplied from the MCU 12 to the audio reproduction device 13 via the serial interface 21 and is supplied to the input end “0” of the selector S2-1 through a writing signal supply line unique to the channel 1 which is provided separately from the third common line L3.

The input end “1” of the selector S2-1 is connected to the third common line L3, and a writing signal VWS-0 of the channel 0 is supplied as a common writing signal.

The selector S2-1 switches a signal output from the output end on the basis of the association setting value stored in the association setting register 33. Specifically, when the association setting value is “0”, a signal input to the input end “0”, that is, the writing signal VWS-1 which is a writing signal unique to the channel 1 is output from the output end. On the other hand, when the association setting value is “1”, a signal input to the input end “1”, that is, the writing signal VWS-0 which is a writing signal common to the channel 0 is output from the output end.

The volume setting registers 32-2 to 32-n also have a constitution similar to that of the volume setting register 32-1. That is, the volume setting registers 32-2 to 32-n are registers for storing volume setting values regarding audio reproduction in the channels 2 to n and have the data input terminal D and the enable terminal E. The data input terminal D of each of the volume setting registers 32-2 to 32-n is connected to the first common line L1. The enable terminal E of each of the volume setting registers 32-2 to 32-n is connected to each of the output ends of the selectors S2-2 to S2-n provided respectively corresponding thereto.

Similar to the selector S2-1, the selectors S2-2 to S2-n are selectors for selectively outputting any one of a signal input to the input end “0” and a signal input to the input end “1” from the output end in accordance with the association setting value stored in the association setting register 33. The writing signals VWS-1 to VWS-n unique to the respective channels are supplied to the input terminal “0” of each of the selectors S2-2 to S2-n. The writing signals VWS-1 to VWS-n are respectively supplied to the input terminals “0” of the selectors S2-2 to S2-n through the writing signal supply lines provided in the respective channels.

The input ends “1” of the selectors S2-2 to S2-n are connected to the third common line L3, and the writing signal VWS-0 of the channel 0 is supplied as a common writing signal.

The association setting register 33 is a register for storing the association setting value indicating whether or not the pitch setting value and the volume setting value of the channel 0 are set in association with the channels 1 to n. The association setting value is supplied from the MCU 12 via the serial interface 21 and is stored in the association setting register 33.

As described above, in the audio reproduction device 13 of the present example, the data input terminal D of each of the pitch setting registers 31-0 to 31-n and the volume setting registers 32-0 to 32-n is connected to the first common line L1 that is a common supply line for supplying the writing data WD. The input ends “1” of the selectors S1-1 to Sl-n are connected to the second common line L2, and the input ends “1” of the selectors S2-1 to S2-n are connected to the third common line L3, respectively. When the association setting value is “1”, a writing signal supplied to each common line, that is, the writing signals PWS-0 and VWS-0 which are writing signals common to the channel 1 are supplied to the corresponding pitch setting register and the corresponding volume setting register. On the other hand, when the association setting value is “0”, supply of a writing signal from each common line is blocked, and writing signals unique to the respective channels are supplied to the corresponding pitch setting register and the corresponding volume setting register.

In other words, the association setting register 33 is a register for storing, as an association setting value, a selective setting value for selecting a pitch setting register and a volume setting register which are blocking targets to be blocked from receiving a common writing signal. In addition, the selectors S1-1 to S1-n and the selectors S2-1 to S2-n are blocking parts blocking supply of a common writing signal with respect to the pitch setting register and the volume setting register selected in accordance with the selective setting value.

That is, the association setting register 33 and the selectors S1-1 to S1-n constitute an association setting part selectively blocking the common writing signal PWS-0 supplied to the second common line L2 with respect to the pitch setting registers 31-1 to 31-n. In addition, the association setting register 33 and the selectors S2-1 to S2-n constitute an association setting part selectively blocking the common writing signal VWS-0 supplied to the third common line L3 with respect to the volume setting registers 32-1 to 32-n.

Next, specific operation of the channel setting part 22 will be described.

When an association setting value “0” is stored in the association setting register 33, in response to this, the selectors S1-1 to S1-n perform switching such that a signal input to the input end “0” is output. Accordingly, association setting is turned off, and the writing signals PWS-1 to PWS-n which are writing signals unique to the respective channels are supplied to the enable terminal E of each of the pitch setting registers 31-1 to 31-n.

Storage of the pitch setting value in the pitch setting registers 31-1 to 31-n is performed separately from storage of the pitch setting value in the pitch setting register 31-0. That is, a different pitch setting value is stored in the pitch setting registers 31-1 to 31-n at a timing different from that of the pitch setting register 31-0.

On the other hand, when an association setting value “1” is stored in the association setting register 33, in response to this, the selectors S1-1 to S1-n perform switching such that a signal input to the input terminal “1” is output. Accordingly, association setting is turned on, and the writing signal PWS-0 which is a writing signal of the channel 0 is supplied in common to the enable terminal E of each of the pitch setting registers 31-1 to 31-n. Therefore, the same pitch setting value is stored in the pitch setting registers 31-1 to 31-n at a timing in association with that of storage of the pitch setting value in the pitch setting register 31-0.

Similarly, switching of the selectors S2-1 to S2-n is also performed in response to storage of the association setting value in the association setting register 33. That is, when the association setting value “0” is stored in the association setting register 33, the selectors S2-1 to S2-n perform switching such that a signal input to the input terminal “0” is output. Accordingly, association setting is turned off, and the writing signals VWS-1 to VWS-n which are writing signals unique to the respective channels are supplied to the enable terminal E of each of the volume setting registers 32-1 to 32-n.

Storage of the volume setting value in the volume setting registers 32-1 to 32-n is performed separately from storage of the volume setting value in the volume setting register 32-0. That is, a different volume setting value is stored in the volume setting registers 32-1 to 32-n at a timing different from that of the volume setting register 32-0.

On the other hand, when the association setting value “1” is stored in the association setting register 33, the selectors S2-1 to S2-n perform switching such that a signal input to the input terminal “1” is output. Accordingly, association setting is turned on, and the writing signal VWS-0 which is a writing signal of the channel 0 is supplied to the enable terminal E of each of the volume setting registers 32-1 to 32-n. Therefore, the same volume setting value is stored in the volume setting registers 32-1 to 32-n at a timing in association with that of storage of the volume setting value in the volume setting register 32-0.

As above, the audio reproduction device 13 of the present example has a constitution in which the association setting register 33 is provided in the channel setting part 22 and the pitch setting value and the volume setting value of the channel 0 can be set in association with a different channel in accordance with the value of the association setting value stored in the association setting register 33.

Generally, when a pitch and a volume are set with respect to an audio reproduction device (LSI) from the outside via a serial interface, since there is a need to store a setting value in a register inside the reproduction device through serial communication, setting values cannot be simultaneously stored with respect to a plurality of channels. For this reason, a time lag occurs between the channels in setting change.

In contrast, in the audio reproduction device 13 of the present example, setting of the pitch and the volume in a plurality of channels during audio reproduction can be changed in association with each other by storing the association setting value in the association setting register 33 in advance and performing association setting. Therefore, the setting value can be changed with respect to a plurality of channels without causing a timing lag between the channels.

Therefore, according to the audio reproduction device 13 of the present example, the pitch and the volume of audio in a plurality of channels can be smoothly adjusted during audio reproduction.

In addition, according to the audio reproduction device 13 of the present example, the MCU 12 (host microcomputer) can complete setting of each channel via the serial interface 21 with minimal communication. Therefore, the MCU 12 can allocate processing capability (resource) required when setting is separately performed for a plurality of channels to other processing.

### EXAMPLE 2

Next, Example 2 of the disclosure will be described. An audio reproduction device of Example 2 differs from the audio reproduction device 13 of Example 1 in the constitution of the channel setting part.

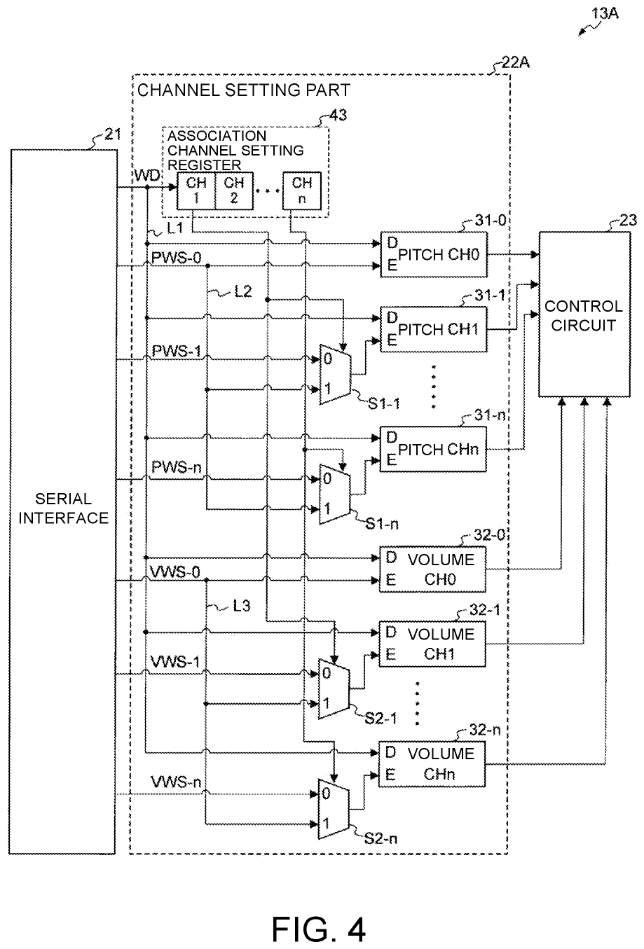

FIG. 4 is a block diagram showing an internal constitution of a channel setting part 22A in an audio reproduction device 13A of the present example.

The channel setting part 22A has an association channel setting register 43 for setting whether or not setting of the pitch and the volume of the channels 1 to n is performed in association with setting of the channel 0.

The association channel setting register 43 has a plurality of association setting registers which are provided respectively corresponding to the channels 1 to n. Storage of the association setting value in each of the association setting registers is performed by the MCU 12 via the serial interface 21.

The association setting register of the channel 1 (which will be indicated as CH1 in the diagrams) is a register for storing the association setting value indicating whether or not the pitch setting value and the volume setting value of the channel 0 are set in association with the channel 1. In other words, the association setting register of the channel 1 is a register for storing the setting value indicating whether or not to block supply of a signal of the second common line L2 (that is, the writing signal PWS-0 of the channel 0) to the pitch setting register 31-1.

Switching of the selector S1-1 and the selector S2-1 is performed in accordance with the association setting value stored in the association setting register of the channel 1. Specifically, when the association setting value is “0”, the selector S1-1 and the selector S2-1 perform switching such that a signal input to the input terminal “0” is output. Accordingly, association setting of the channel 1 is turned off, and the writing signal PWS-1 which is a writing signal unique to the channel 1 is supplied to the enable terminal E of the pitch setting register 31-1. In addition, the writing signal VWS-1 which is a writing signal unique to the channel 1 is supplied to the enable terminal E of the volume setting register 32-1.

Storage of the pitch setting value in the pitch setting register 31-1 is performed separately from storage of the pitch setting value in the pitch setting register 31-0. That is, a different pitch setting value is stored in the pitch setting register 31-1 at a timing different from that of the pitch setting register 31-0. In addition, storage of the volume setting value in the volume setting register 32-1 is performed separately from storage of the volume setting value in the volume setting register 32-0. That is, a different volume setting value is stored in the volume setting register 32-1 at a timing different from that of the volume setting register 32-0.

On the other hand, when the association setting value is “1”, the selector S1-1 and the selector S2-1 perform switching such that a signal input to the input terminal “1” is output. Accordingly, association setting of the channel 1 is turned on, and the writing signal PWS-0 which is a writing signal of the channel 0 is supplied to the enable terminal E of the pitch setting register 31-1. In addition, the writing signal VWS-0 which is a writing signal of the channel 0 is supplied to the enable terminal E of the volume setting register 32-1.

Accordingly, the same pitch setting value is stored in the pitch setting register 31-1 at a timing in association with that of storage of the pitch setting value in the pitch setting register 31-0. In addition, the same volume setting value is stored in the volume setting register 32-1 at a timing in association with that of storage of the volume setting value in the volume setting register 32-0.

Similarly, each of the association setting registers of the channels 2 to n (which will be indicated as CH2 to CHn in the diagrams) is a register for storing the association setting value for each channel indicating whether or not the pitch setting value and the volume setting value of the channel 0 are set in association with the channels 2 to n. Switching of the selectors S1-2 to S1-n and the selectors S2-2 to S2-n is performed in accordance with the association setting value for each channel stored in each of the association setting registers of the channels 2 to n.

Specifically, when the association setting value of a channel k (k is an integer from 2 to n) is “0”, a selector S1-k and a selector S2-k perform switching such that a signal input to the input terminal “0” is output. Accordingly, association setting of the channel k is turned off, and a writing signal PWS-k which is a writing signal unique to the channel k is supplied to the enable terminal E of a pitch setting register 31-k. In addition, a writing signal VWS-k which is a writing signal unique to the channel k is supplied to the enable terminal E of a volume setting register 32-k.

Storage of the pitch setting value in the pitch setting register 31-k is performed separately from storage of the pitch setting value in the pitch setting register 31-0. That is, a different pitch setting value is stored in the pitch setting register 31-k at a timing different from that of the pitch setting register 31-0. In addition, storage of the volume setting value in the volume setting register 32-k is performed separately from storage of the volume setting value in the volume setting register 32-0. That is, a different volume setting value is stored in the volume setting register 32-k at a timing different from that of the volume setting register 32-0.

On the other hand, when the association setting value of the channel k is “1”, the selector S1-k and the selector S2-k perform switching such that a signal input to the input terminal “1” is output. Accordingly, association setting of the channel k is turned on, and the writing signal PWS-0 which is a writing signal of the channel 0 is supplied to the enable terminal E of the pitch setting register 31-k. In addition, the writing signal VWS-0 which is a writing signal of the channel 0 is supplied to the enable terminal E of the volume setting register 32-k.

The same pitch setting value is stored in the pitch setting register 31-k at a timing in association with that of storage of the pitch setting value in the pitch setting register 31-0. In addition, the same volume setting value is stored in the volume setting register 32-k at a timing in association with that of storage of the volume setting value in the volume setting register 32-0.

As above, the audio reproduction device 13A of the present example has a constitution in which the association channel setting register 43 is provided in the channel setting part 22A and it is possible to set for each channel whether or not the pitch setting value and the volume setting value of the channel 0 are set in association with a different channel. Therefore, the pitch and the volume can be adjusted promptly with a high degree of freedom by setting the association setting value for the association setting register of each channel in the association channel setting register 43 in advance and selecting channels intended to be set in association with the channel 0 and channels intended to be set separately from the channel 0.

The disclosure is not limited to the foregoing embodiment. For example, in the foregoing examples, a case of changing setting of the pitch and the volume has been described as an example, but target setting is not limited to this, and the disclosure can be generally applied to cases of changing a setting value related to reproduction control of audio (reproduction setting value). For example, the setting value may be changed targeting on other reproduction parameters related to reproduction of audio, such as a filter coefficient. In addition, setting related to instruction of reproduction, such as whether or not to stop reproduction of audio or whether or not to loop the same phrase, may be constituted to be perform for each channel.

In addition, in the foregoing Example 1, a case in which association setting is not performed when the association setting value stored in the association setting register 33 is “0” and association setting is performed with respect to both the pitch setting value and the volume setting value when the association setting value is “1” has been described as an example. However, association setting with respect to the pitch setting value and association setting with respect to the volume setting value may be constituted to be able to be performed separately from each other. For example, association setting of the pitch setting value and association setting of the volume setting value can be performed separately from each other by providing a first association setting register for setting a pitch and a second association setting register for setting a volume and independently controlling the association setting value for each of the association setting registers. Regarding Example 2 as well, association setting of the pitch setting value and association setting of the volume setting value for each channel can be performed separately from each other by separately providing an association channel setting register for setting a pitch and an association channel setting register for setting a volume.

In addition, in each of the foregoing examples, a case in which the MCU 12 sets the setting values of the pitch and the volume for each register provided in the channel setting part 22 of the audio reproduction device 13 via the serial interface 21 has been described as an example. However, unlike this, for example, the foregoing setting may be constituted to be performed with respect to the audio memory 24.

In addition, in each of the foregoing examples, a case in which the audio reproduction device constitutes a vehicle approach notification system has been described as an example. However, the constitution of the audio reproduction device of the disclosure is not limited to that mounted in a vehicle approach notification system and can be applied to all devices performing reproduction of audio.

What is claimed is:

1. An audio reproduction device capable of simultaneously reproducing audio in a plurality of channels, the audio reproduction device comprising:
a reproduction control part which reproduces audio in each of (n+1) channels (n is a natural number);
(n+1) reproduction setting value registers which are provided respectively corresponding to the (n+1) channels and store a reproduction setting value that is a setting value related to reproduction control of audio reproduced in each channel;
a first common line which is shared by the (n+1) reproduction setting value registers and through which the reproduction setting value is supplied from the outside;
a second common line which is shared by the (n+1) reproduction setting value registers and through which a common writing signal for storing the reproduction setting value in the reproduction setting value register that has received supply of the reproduction setting value via the first common line is supplied; and
an association setting part which is able to selectively block the common writing signal supplied to the second common line with respect to one or a plurality of the reproduction setting value registers.

2. The audio reproduction device according to claim 1,
wherein the association setting part includes a selection setting register storing a selective setting value indicating a selection form of the reproduction setting value register to be blocked from receiving the common writing signal, and a blocking part blocking the common writing signal supplied to the reproduction setting value register selected in accordance with the selective setting value.

3. The audio reproduction device according to claim 2,
wherein the (n+1) reproduction setting value registers are constituted of a first reproduction setting value register provided respectively corresponding to a first channel, and second to (n+1)th reproduction setting value registers provided respectively corresponding to second to (n+1)th channels,
wherein the audio reproduction device further has second to (n+1)th individual signal lines which are provided respectively corresponding to the second to (n+1)th reproduction setting value registers and receive supply of writing signals unique to the respective channels, and
wherein the blocking part includes second to (n+1)th selectors provided respectively corresponding to the second to (n+1)th reproduction setting value registers and selectively supplying any one of a signal supplied to each of the second to (n+1)th individual signal lines and a signal supplied to the second common line to the second to (n+1)th reproduction setting value registers based on the selective setting value.

4. The audio reproduction device according to claim 3,
wherein each of the (n+1) reproduction setting value registers has a data input part receiving supply of the reproduction setting value as writing data, and a signal input part receiving supply of the common writing signal or writing signals unique to the respective channels, and
wherein each of the second to (n+1)th selectors selectively connects any one of the second to (n+1)th individual signal lines and the second common line to the signal input part based on the selective setting value.

5. The audio reproduction device according to claim 4,
wherein the reproduction setting value includes a pitch setting value that is a setting value for a frequency of audio reproduced in each channel, and
wherein each of the (n+1) reproduction setting value registers includes a pitch register storing the pitch setting value.

6. The audio reproduction device according to claim 4,
wherein the reproduction setting value includes a volume setting value that is a setting value for a sound volume of audio reproduced in each channel, and
wherein each of the (n+1) reproduction setting value registers includes a volume register storing the volume setting value.

7. The audio reproduction device according to claim 3,
wherein the second common line supplies a writing signal with respect to the first reproduction setting value register to the second to (n+1)th reproduction setting value registers as the common writing signal, and
wherein the selection setting register stores, as the selective setting value, a setting value for selecting whether to perform supply of the common writing signal or block supply of the common writing signal with respect to all of the second to (n+1)th reproduction setting value registers.

8. The audio reproduction device according to claim 4,
wherein the second common line supplies a writing signal with respect to the first reproduction setting value register to the second to (n+1)th reproduction setting value registers as the common writing signal, and
wherein the selection setting register stores, as the selective setting value, a setting value for selecting whether to perform supply of the common writing signal or block supply of the common writing signal with respect to all of the second to (n+1)th reproduction setting value registers.

9. The audio reproduction device according to claim 5,
wherein the second common line supplies a writing signal with respect to the first reproduction setting value register to the second to (n+1)th reproduction setting value registers as the common writing signal, and
wherein the selection setting register stores, as the selective setting value, a setting value for selecting whether to perform supply of the common writing signal or block supply of the common writing signal with respect to all of the second to (n+1)th reproduction setting value registers.

10. The audio reproduction device according to claim 6,
wherein the second common line supplies a writing signal with respect to the first reproduction setting value register to the second to (n+1)th reproduction setting value registers as the common writing signal, and
wherein the selection setting register stores, as the selective setting value, a setting value for selecting whether to perform supply of the common writing signal or block supply of the common writing signal with respect to all of the second to (n+1)th reproduction setting value registers.

11. The audio reproduction device according to claim 2,
wherein the selection setting register includes n setting registers provided respectively corresponding to the (n+1) reproduction setting value registers, and
wherein each of the n setting registers individually stores, as the selective setting value, a setting value for each channel for selecting whether to supply the common writing signal to the corresponding reproduction setting value register or block the common writing signal.

12. The audio reproduction device according to claim 3,
wherein the selection setting register includes n setting registers provided respectively corresponding to the (n+1) reproduction setting value registers, and
wherein each of the n setting registers individually stores, as the selective setting value, a setting value for each channel for selecting whether to supply the common writing signal to the corresponding reproduction setting value register or block the common writing signal.

13. The audio reproduction device according to claim 4,
wherein the selection setting register includes n setting registers provided respectively corresponding to the (n+1) reproduction setting value registers, and
wherein each of the n setting registers individually stores, as the selective setting value, a setting value for each channel for selecting whether to supply the common writing signal to the corresponding reproduction setting value register or block the common writing signal.

14. The audio reproduction device according to claim 5,
wherein the selection setting register includes n setting registers provided respectively corresponding to the (n+1) reproduction setting value registers, and
wherein each of the n setting registers individually stores, as the selective setting value, a setting value for each channel for selecting whether to supply the common writing signal to the corresponding reproduction setting value register or block the common writing signal.

15. The audio reproduction device according to claim 6,
wherein the selection setting register includes n setting registers provided respectively corresponding to the (n+1) reproduction setting value registers, and
wherein each of the n setting registers individually stores, as the selective setting value, a setting value for each channel for selecting whether to supply the common writing signal to the corresponding reproduction setting value register or block the common writing signal.

16. An audio reproduction LSI comprising:
a reproduction control part which reproduces audio in each of (n+1) channels (n is a natural number);
(n+1) reproduction setting value registers which are provided respectively corresponding to the (n+1) channels and store a reproduction setting value that is a setting value related to reproduction control of audio reproduced in each channel;
a first common line which is shared by the (n+1) reproduction setting value registers and through which the reproduction setting value is supplied from the outside;
a second common line which is shared by the (n+1) reproduction setting value registers and through which a common writing signal for storing the reproduction setting value in the reproduction setting value register that has received supply of the reproduction setting value via the first common line is supplied; and
an association setting part which is able to selectively block the common writing signal supplied to the second common line with respect to one or a plurality of the reproduction setting value registers.
